(19) United States
(12) Patent Application Publication
(10) Pub. No.: US 2023/0093317 A1
(43) Pub. Date: Mar. 23, 2023

(54) POULTRY FOOD PRODUCT AND BUTCHERING PROCESS

(71) Applicants: Ted Vernon Kuck, Saint Marys, OH (US); Karl Martin Kuck, Saint Marys, OH (US); Stuart James Kuck, New Knoxville, OH (US)

(72) Inventors: Ted Vernon Kuck, Saint Marys, OH (US); Karl Martin Kuck, Saint Marys, OH (US); Stuart James Kuck, New Knoxville, OH (US)

(21) Appl. No.: 17/821,928

(22) Filed: Aug. 24, 2022

Related U.S. Application Data
(60) Provisional application No. 63/260,527, filed on Aug. 24, 2021.

(51) Int. Cl. A23L 13/50; A22C 21/00

(52) U.S. Cl. CPC A23L 13/55; A22C 21/0084

(57) ABSTRACT

A poultry food product and a method of making a poultry food product. The poultry food product comprises one or more bare poultry bones separated from the remainder of a poultry wing. Where the poultry food product includes the one or more bare poultry bones with a quantity of processed poultry meat surrounding and coupled to the bare poultry bones.

### CROSS-REFERENCE TO RELATED APPLICATIONS

This application claims the benefit of U.S. Provisional Pat. Application Serial No. 63/260,527, filed on Aug. 24, 2021, the benefit of priority of which is claimed hereby, and which is incorporated by reference herein in its entirety.

### TECHNICAL FIELD

The present disclosure is directed to food processing and food products, such as poultry butchering and poultry food preparation.

### BACKGROUND

Animal based food products (animal products) are food products derived from the body of an animal. Examples of animal products include fat, flesh or muscle, blood, milk, or eggs. Animal by-products can be carcasses, parts of carcasses and products of animal origin that are discarded.

A main source of protein for humans can include animal meat, such as meat from livestock (cows, pigs, sheep, goats, etc.), fish (including shellfish and mollusks), and poultry (chicken, turkey, ducks, etc.). Mammalian animal meat is typically classified as red meat. Whereas meat from poultry or fish is typically classified as white meat. Red meat and white meat can be harvested for human consumption.

To harvest an animal, the animal is generally butchered into smaller, more manageable pieces. For example, a cow is butchered into specific cuts of meat some of which are ‘bone-in’ (e.g., a T-bone steak, ribs, ribeye or the like) or boneless, such as a filet, prime rib, New York strip or the like. In another example, a chicken may be butchered into specific cuts of meat, such as a breast or leg. Similarly, when butchering poultry, the animal meat may be presented with or without the skeletal structure attached to the desired meat, such as a bone-in chicken breast or boneless chicken breast. However, a chicken may be presented whole and not broken down.

When a boneless product is desired, animal by-products remain such as bones, organs, and appendages. These animal by-products may be processed for consumption by animals as feed, or in other examples are discarded as waste.

When a bone-in product is desired, the associated skeletal structure remains with the muscle attached to the bone. Any other parts of the animal are detached from the desired bone-in cut of meat. In some examples, other parts of the animal are further butchered for other cuts, used for other purposes, or considered waste and discarded.

### SUMMARY

In the food industry there has been a movement away from red meat such as beef, pork, lamb and veal. Part of this shift has been toward poultry (white meat) products as a healthier, lower fat option. Another reason for the switch from red meat to poultry is to reduce the potential carbon impact red meat animals have on the environment. As stated in a report by the University of Michigan, the carbon impact of poultry is estimated to be about one-third that of red meat animals. (See http://css.umich.edu/factsheets/carbon-footprint-factsheet) Whether a person is consuming less red meat for health reasons or environmental reasons, that person may want a poultry-based food product that is reminiscent of a red meat product. Therefore, poultry food product producers have begun to create red meat-like items, such as sausage, burgers, bacon or the like from poultry products (e.g., chicken sausage, turkey burgers, turkey bacon or the like).

The present inventors have recognized, among other things, that a problem to be solved includes producing a poultry-based food product that appears similar to other on-bone red meat products such as, but not limited to, ribs, steaks, chops or the like. The inventors have recognized there are, in some examples, difficulties in acquiring the necessary components, such as component bones, to form a specified structure of the food product. Poultry bones are difficult to obtain because poultry meat is, in many examples, harvested from a carcass and the remainder of the carcass including the skeletal structure is discarded as waste. Or in other examples, poultry meat remains on the associated bones and the tangential bones of the carcass are discarded as waste.

In other examples, if the poultry carcass is available, it is difficult to obtain poultry bones having a similar appearance to red meat bones. For instance, the rib bones of red meat carcasses have a recognized shape, size, form or the like (herein profile). Poultry bones can differ significantly in form or structure from red meat carcass bones, such as rib bones.

The present inventors have contemplated acquiring a poultry bone, such as an ulna or radius bone of a poultry wing, which can have a similar appearance or profile to a red meat bone, such as a rib bone. In one example, the poultry bone is harvested directly from an intact poultry carcass that is otherwise discarded. In another example, the poultry bone is harvested from a discarded poultry wing that is otherwise discarded.

In one example of harvesting a poultry bone, the skin from a poultry carcass is removed exposing the meat of the poultry carcass. In an example, the meat surrounding the skeletal structure is removed, stripped or cleaned and the bare (e.g. entirely cleaned, or removed with incidental meat remaining) skeletal structure remains. After removal of the meat, the poultry bone, such as the bare ulna or radius bone is separated from the wing.

In another example of harvesting a poultry bone, the skin from a poultry wing is removed from the area of the desired bone. For instance, the skin from the area of the poultry wing surrounding the ulna and radius bones is removed. The meat surrounding the ulna or radius bone is removed. The ulna or radius bone, in some examples, has the meat and skin removed before the bare bone (e.g., entirely cleaned, or with some incidental meat remaining) is decoupled from the remainder of the skeletal structure.

After removal of the meat from the area surrounding the desired either ulna or radius bone, the bare ulna bone is separated from the radius bone. The desired ulna or radius bone is then separated from the poultry carcass, and ready for potential food product processing.

In another example of harvesting a bone from a poultry wing, the ulna and the radius bones are separated from the remainder of the wing while joined together. In an example, the skin and meat from the separated ulna and radius bone are removed (e.g., bare, entirely cleaned or with some incidental meat remaining). The ulna bone is then separated from the radius bone.

The present inventors have recognized, among other things, a problem to be solved includes using a poultry bone with a quantity of processed poultry meat to form a food product similar to on-bone red meat products. In an example, the poultry bone of the poultry food product is a bone harvested from a poultry carcass. A harvested bone, in some instances, is from a poultry wing either before or after the poultry wing is separated from the carcass. In an example where the ulna is desired, the ulna is separated from the poultry carcass before or after the remaining portions of the poultry wing are harvested. In an example where the radius is desired, the radius is separated from the poultry carcass before or after the remaining portions of the poultry wing are harvested.

In one example, the poultry food product (such as a poultry ‘rack of ribs’ or a poultry ‘chop’) produced with one or more of the harvested bones as a similar profile to a typical red meat product. In such an example, a bone-in red meat product, such as ribs or chop, are produced using poultry. For instance, the skeletal structure of a poultry carcass is harvested as discussed herein and individual poultry bones serve as the framework, support or base of the bone-in poultry food product.

In an example of a poultry food product where a specific bone is desired, the specific bone is harvested either before or after at least some of the muscle and skin surrounding the specific bone are stripped to provide a bare bone (e.g., entirely cleaned or with some incidental meat remaining). In the example where a bare bone is harvested, the bare bone is used as the framework, support or base of the food product.

In an example poultry food product that uses a clean bone, one or more clean bones are surrounded (e.g., partially covered or completely covered) with processed poultry meat. The processed poultry meat is coupled through further processing to the one or more harvested (otherwise clean) poultry bones. The poultry food product with the processed poultry meat coupled to the one or more harvested bones has the appearance of a bone-in red meat food product.

In one example of a poultry bone that is similar to the profile of a red meat bone, an ulna bone is has the appearance of a red meat rib bone. In another example of a poultry bone that is similar to the profile of a red meat bone, a radius bone has the appearance of a red meat rib bone. Processed poultry meat coupled with the one or more harvested bare ulna or radius bones has the appearance of red meat ribs.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is a bottom view of an example poultry food product in packaging with the poultry bones exposed.

FIG. 1B is a top view of the poultry food product of FIG. 1A in packaging with the processed poultry meat.

FIG. 2 is a top view of a comparison of a poultry wing with skin and an example disassembled poultry wing.

FIG. 3 is a top view of the skeletal structure of a poultry wing.

FIG. 4 is a top view of the poultry wing with and without skin.

FIG. 5. is a top view of a poultry wing of FIG. 4 with stripped and bare ulna and radius bones.

FIG. 6 is a top view of the poultry wing of FIG. 4 with the stripped and bare ulna and radius bones separated at a carpal joint.

FIG. 7 is a top view of the poultry wing of FIG. 4 with the stripped and bare ulna bone separated from the remainder of the poultry wing.

FIGS. 8A — 8E illustrate top views of a progression of removal of a poultry bone from a poultry wing.

FIG. 9 is a top view with a plurality of poultry bones arranged for processing of a poultry food product.

FIG. 10 is a comparison view of the poultry food product before processed poultry meat surrounds the bones and an assembled poultry food product.

FIG. 11 is a detailed view of the assembled poultry food product.

FIGS. 12A — C are top views of a bare bone next to an assembled food product.

### DETAILED DESCRIPTION

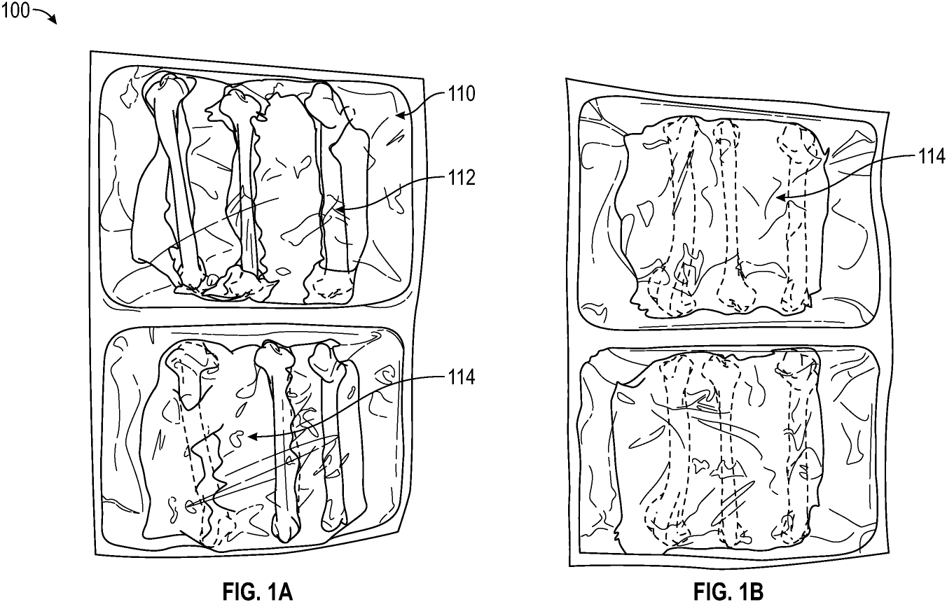

FIGS. 1A and 1B are illustrations of a poultry food product 100 produced from harvested poultry bones and a quantity of processed poultry meat. The poultry bones are acquired by one or more of butchering or harvesting desired anatomical areas, such as a poultry wing, or through a source of discarded bones. In examples of butchering or harvesting specific anatomical area such as a poultry wing, the wing may be harvested to obtain the muscle, or meat, attached to the bone. Poultry meat is detached from the bone structure for further processing (e.g., ground poultry meat, poultry deli meat, boneless wings) or use in other food products (e.g., soups, casseroles, prepackaged meals). The wing can, in other examples, be harvested to obtain sections of the poultry wing to create bone-in food products. In each of the previous examples, the unused poultry bones are optionally discarded.

FIG. 1A is a depiction of a bottom view of poultry food products 100 produced from harvested poultry bones and a quantity of processed poultry meat in packaging 110. As discussed further below, processed poultry meat means any poultry meat which has been stripped from the bone. Processed poultry meat includes, but is not limited to, poultry meat which is whole-muscle, cut, chopped, emulsified or otherwise made into smaller pieces. Processed poultry meat includes poultry meat which has been brined, seasoned, or had other ingredients added. Processed poultry meat is also, in some examples, a combination of any of the previously mentioned cuts or pieces of poultry meat and additional ingredients added to the poultry meat, or any other similarly related processes. FIG. 1B is a depiction of a top view of a poultry food product 100 in packaging 110. The poultry food product 100 shown in FIGS. 1A and 1B are an example of a food product having a similar profile (e.g., shape, size, color, appearance or the like) to a red meat food product. The example poultry food product 100 shown in FIGS. 1A and 1B have a similar profile to a pork or beef rack of ribs.

FIGS. 1A and 1B are examples of a poultry food product 100 in packaging 110, for instance before the product is ready for consumption. The processed poultry meat 114 (e.g., raw, partially processed or the like) is placed on, around or surrounds the poultry bone 112. The poultry bones 112 used in the poultry food product are acquired from one or more of a poultry carcass or a third-party source of discarded poultry bones. The assembly of the processed poultry meat on the bones is further processed to create a bone-in food product with the poultry meat coupled (e.g., adhered, bonded or the like) to the poultry bones.

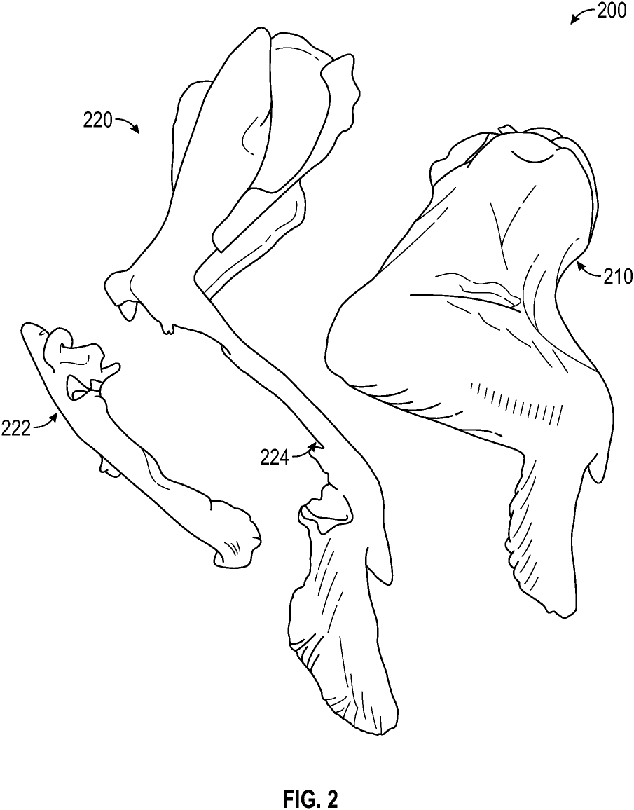

The poultry food product 100 illustrated in FIGS. 1A and 1B is formed from a poultry bone 112 harvested, for example, from a poultry wing 200, as shown in FIG. 2. FIG. 2 illustrates an intact poultry wing 210 side by side with a disassembled poultry wing 220. The poultry wing 200 includes, but is not limited to, a turkey, chicken, duck, goose wing or wing from another fowl. In the present example, a turkey wing is shown.

When the poultry wing 200 is harvested from the whole bird the skin, in some examples, is retained with the wing structure. In other examples, the skin is partially or completely removed from the poultry wing 200 before butchering, thereby forming a skinless poultry wing. Butchering the skinless poultry wing provides for ease in discerning the locations for cuts in the wing structure. For example, butchering a skinless poultry wing allows for the exposure of the wing structure at desired locations to expose and identify specific bones, such as the ulna 222 or radius 224.

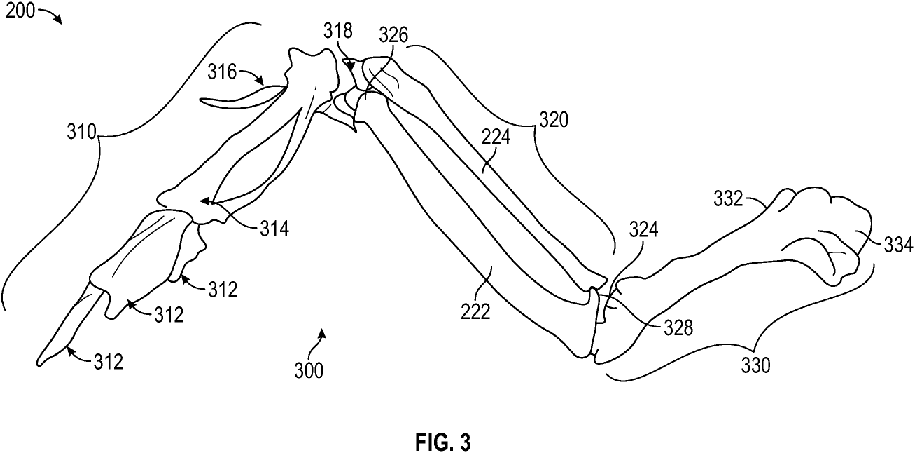

FIG. 3 illustrates the skeletal structure 300 of the poultry wing 200. The manus 310 includes the phalanges 312, the metacarpus 314, the alula 316 and at the proximal end of the manus 310 is the carpal joint 318. A forearm 320 of the poultry wing includes the radius 224 and ulna 222 bones (e.g., radius-ulna subassembly). The forearm 320 joins with the manus 310 at the carpal joint 318 and terminates at the elbow joint 324. The ulna 222 and radius 224 are coupled at the carpal joint 318 at the ulnar notch 326 and coupled at the elbow joint 324 at the radial notch 328. An upper arm 330 of the poultry wing 200 includes the humerus bone 332. The humerus bone 332 is coupled with the ulna 222 and radius 224 at the elbow joint 324 at a distal end of the humerus bone 332, and on the proximal end is coupled with a shoulder at a shoulder joint 334.

In the construction of the example poultry food product 100 which has a similar profile to a red meat product such as a rack of ribs (e.g., pork ribs or beef ribs), the ulna 222 or the radius 224 are harvested from the wing. The ulna 222 and radius 224, individually, can have similar profiles to rib bones from a pig or a cow.

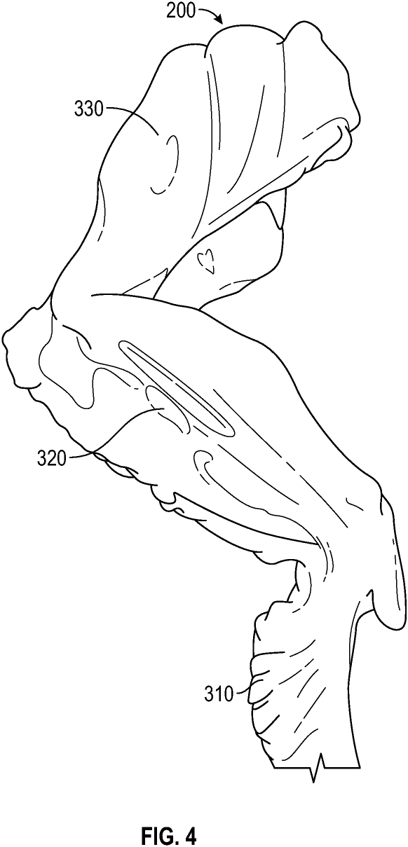

FIG. 4 illustrates an example a poultry wing 200 with the skin at least partially removed. With the skin removed from the poultry wing 200, the poultry wing 200 can be readily unfolded with each of the manus 310, forearm 320 and upper arm 330 distinct from the other. With the skin removed, in one example the sections of the wing are readily identified and butchering the wing, for instance at one or more joints, with one or more cuts or the like is easier. In an example, a butcher identifies the location of either or both the radius and ulna bones in the forearm section. The butcher can cut in specified locations to facilitate removal of either or both of the radius and ulna bones.

A bone-in food product containing the bone and associated muscle or meat (hereinafter, muscle or meat are used interchangeably) is, in some examples, produced at least in part from poultry wings and the remainder of the poultry wing is discarded. In one such example, a butcher harvests the desired bone and meat, and the unwanted skeletal structure is discarded. The meat can be the specified component of interest from the wing, and accordingly what remains are stripped bones (e.g., cleaned, with some incidental meat remaining, entirely cleaned or the like). In some examples, the stripped bones are discarded or considered waste.

In another example, a bone-in food product containing both the humerus bone 332 and radius bone 224 and associated meat is specified. In this example, the ulna 222 and manus 310 are removed from the desired wing sections and discarded. In another example, the radius is desired (in contrast to the humerus and radius) with the surrounding and associated meat. In this example, the ulna and remaining portions of the poultry wing are discarded.

In still another example, the meat surrounding each of the sections, manus 310, mid-section 320 and upper arm 330, is harvested for boneless meat products. For example, the harvested meat is processed as boneless poultry wings, meat for prepackaged meals, deli meat or animal consumption. After the meat is removed from the skeletal structure 300, the stripped bones 300 can be discarded or considered waste.

The harvested stripped bones, such as the radius 224 and the ulna 222, when not discarded, can be, individually or together, used to form the food product 100 which can be similar in profile or appearance to a red-meat food product, as shown, for example, in FIGS. 1A and 1B. The process for forming the food product 100 similar in profile or appearance to a red-meat food product is discussed below.

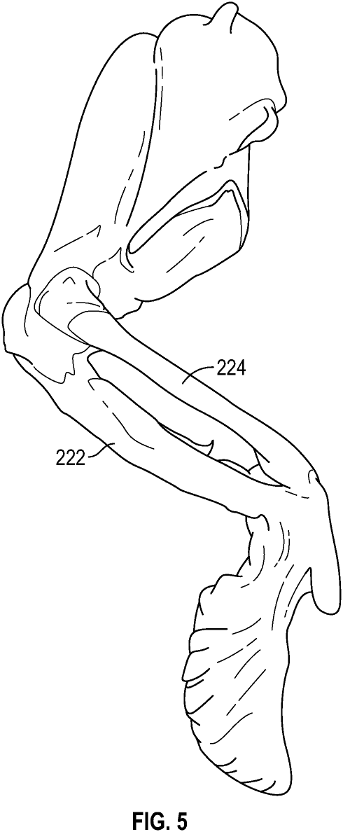

FIG. 5 illustrates a poultry wing 200 after the meat surrounding both the ulna 222 and radius 224 are exposed. In the example illustrated in FIG. 5, the ulna 222 and radius 224 are harvested in a manner that strips the meat surrounding these bones while the remaining structure of the wing retains meat there on, thereby resulting in bare bones (e.g., cleaned, with some incidental meat remaining, entirely cleaned or the like). As shown, the stripped and bare ulna 222 and radius 224 in this example have remnants of meat retained on the bones. In other examples, the quantity of meat retained is more or less (e.g., with incidental or no meat remaining on the bones). Stripping the meat from both the ulna 222 and radius 224 facilitates enhanced visualization by a butcher during the process of harvesting individual bones.

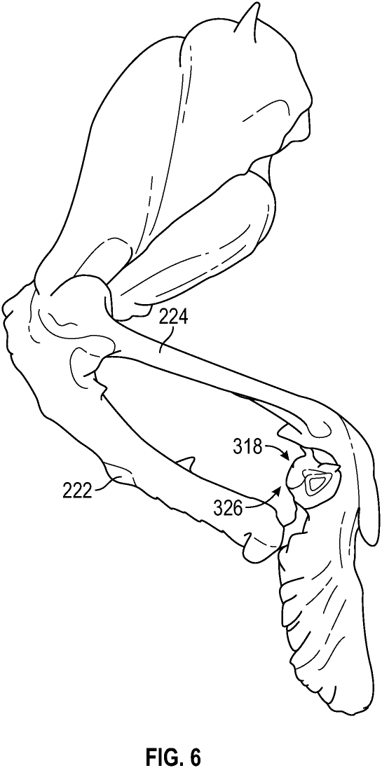

FIG. 6 illustrates the poultry wing 200 during the harvesting process. In the example shown in FIG. 6, a cut has been made at either the carpal joint 318 or the ulnar notch 326 or both the carpal joint 318 and the ulnar notch 326 (also shown in FIG. 3). By making a cut at either or both the carpal joint 318 or the ulnar notch 326, as indicated above, the radius 224 and the ulna 222 are separated at one end while remaining coupled at the other. During the process of cutting at either or both the carpal joint 318 and ulnar notch 326, the skeletal structure of the individual bones remains intact to maintain the profile of the bones.

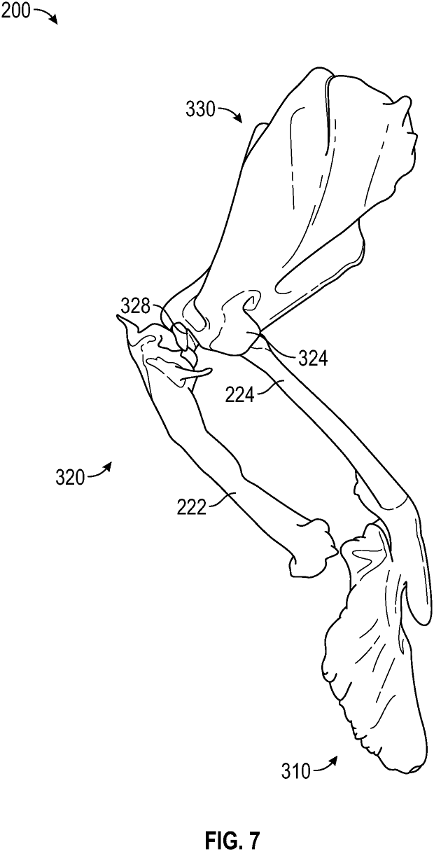

FIG. 7 illustrates a poultry wing 200 during another step in the harvesting process. In the example shown in FIG. 7, a cut has been made at either the elbow joint 324 or the radial notch 328 or both of the elbow joint 324 and the radial notch 328 (also shown in FIG. 3). By making a cut at either or both of the elbow joint 324 or the radial notch 328, as discussed above, the radius 224 and the ulna 222 are separated at the other end. In an example, the ulna 222 is removed from the skeletal structure of the poultry wing 200 while the radius 224 remains coupled to the structure of the poultry wing 200. Harvesting the ulna 222 with a cut at either or both of the carpal joint 318 or the ulnar notch 326 and a cut at either or both of the elbow 324 or the radial notch 328 maintains the profile of the ulna 222. As discussed herein, the ulna 222 with the maintained (or preserved) profile can be a component of a poultry food product.

A similar process, as the example for harvesting the ulna, also harvests the radius. In such an example, cuts are made at either or both of the carpal joint 318 or the ulnar notch 326 and a cut at either or both of the elbow 324 or the radial notch 328. In this example, the cuts are made in the direction of the radius 224 to decouple the radius 224 from the ulna 222. The ulna 222 remains attached, or coupled, to the remainder of the poultry wing 200. By cutting toward the radius 224 the profile of the radius 224 is maintained to facilitate use of the full profile of the radius 224 (including a near full profile) in a poultry food product as discussed herein.

In another example, both of the ulna 222 and the radius 224 are harvested from the poultry wing 200 thereby separating the manus section 310, the forearm section 320 and the upper arm section 330. With harvesting of the ulna 222 and the radius 224 similar cuts are made at either or both of the carpal joint 318 or the ulnar notch 326 and at either or both of the elbow 324 or the radial notch 328. The angle of the cut separates, for example, the individual bones with minimal damage to the profiles of the radius 224 and ulna 222 (e.g., no damage or nominal damage).

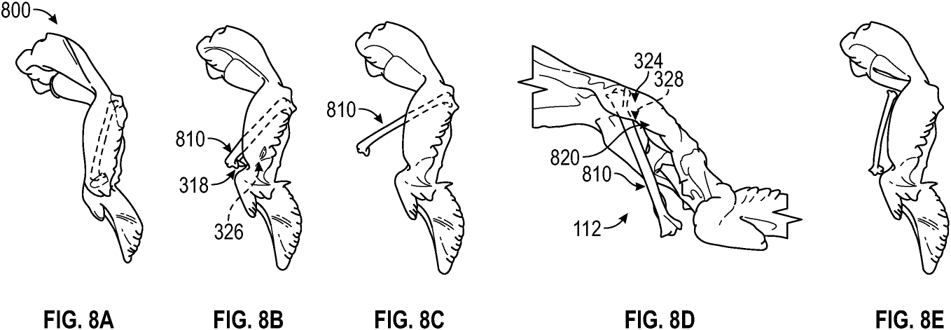

FIGS. 8A — 8E illustrate another example of harvesting a poultry bone 100, such as a radius bone 810, from a poultry wing 800. The poultry wing 800 optionally has the skin removed before making cuts, as shown in FIG. 8A. The muscle or meat (hereinafter, muscle or meat are used interchangeably) and the remaining skeletal structure remain intact. In FIG. 8B, a cut is made proximate to the location of the desired poultry bone in the muscle surrounding the bone. In the example shown in FIG. 8B, the radius bone 810 is partially detached from the poultry wing 800 with the cut. The cut can detach the radius bone 810 from the carpal joint 318 and the ulnar notch 326, and the radius bone 810 can be pulled from the muscle or meat, as illustrated in FIG. 8C.

Referring now to the example illustrated in FIG. 8D, a cut 820 in the muscle is opened to expose the full length of the radius bone 810. Opening the cut 820 exposes the radius bone 810 and provides access to the elbow joint 324 and the radial notch 328 for additional cuts at those locations. The cuts made at the elbow joint 324 and radial notch 328 separate the radius bone 810 from the remainder of the poultry wing 800 with minimal damage (e.g., none or nominal) to the profile of the radius bone 810. At the same time, the remainder of the poultry wing 800 remains intact, as shown in FIG. 8E. Accordingly, the remainder of the poultry wing 800 is ready for further processing, such as harvesting of meat or the like.

A similar process as the examples illustrated in FIGS. 8A-8E for harvesting the radius bone is conducted to harvest the ulna bone. In such an example, the muscle is cut proximate to the ulna bone. Cuts are made at the carpal joint and the ulnar notch separating the ulna. Cuts are made at the elbow joint and radial notch to separate and harvest the ulna bone from the poultry wing.

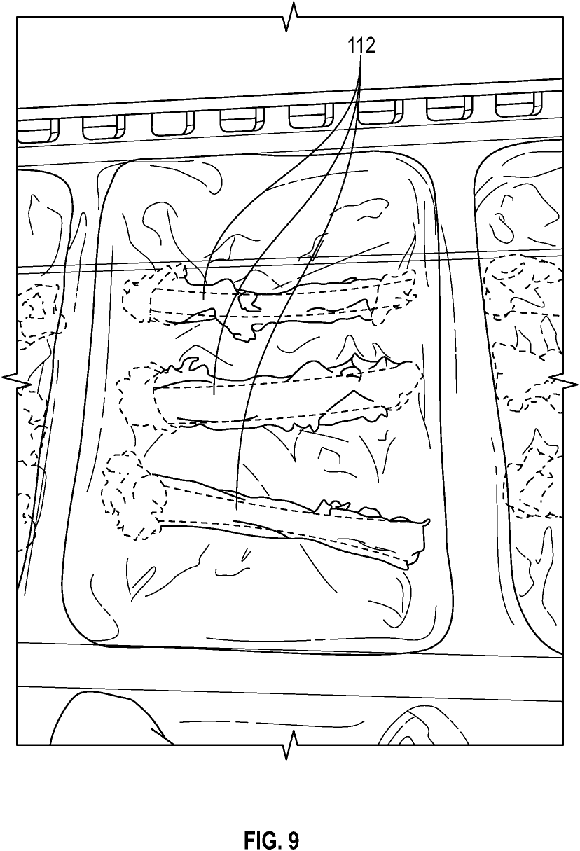

FIG. 9 illustrates an example of a part of the process for forming a poultry food product 100 (as shown in FIG. 1) using specific poultry bones 112 having a similar profile to a bone-in, red meat food product. As discussed previously, bare (e.g. cleaned, entirely cleaned, or removed with incidental meat remaining) poultry bones are harvested. In an example, the harvested bare bones 112 are brined in a solution.

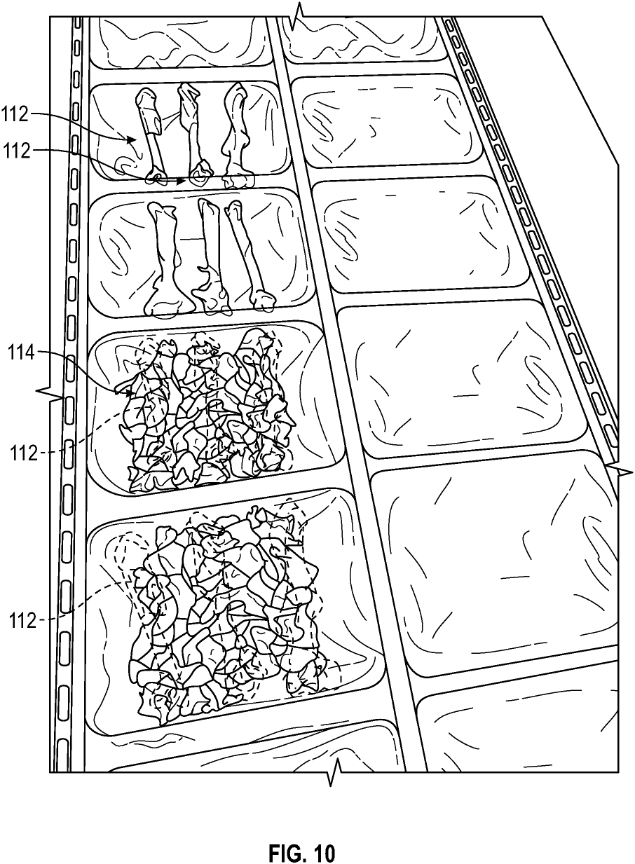

Brining the bare poultry bones 112 causes the processed poultry meat 114 (as shown in FIGS. 1 and 10) to couple (e.g. connect, bind, adhere, encapsulate, envelope, capture or the like) to the bare poultry bone 112. The bare poultry bones 112 are brined, for example, in a solution of a mixture of dry ingredients including, but not limited to salt, tripoly phosphate and sugar combined with water. The bare poultry bones are immersed in the solution. The poultry bones 112, in an example, are also mixed after being immersed in the solution. In an example, the brining process (e.g. immersed in a solution or immersed and mixed in a solution) is performed under vacuum or low pressure conditions. In another example, the immersion/mixing process is performed at or near ambient pressure.

As illustrated in FIG. 9, one or more bare and brined poultry bones 112 are arranged on a substrate (e.g., in packaging, a container, or on a surface such as a tray or film). In one example, the poultry food product 100 (illustrated in FIG. 1) uses bare poultry bones 112 such as bare radius or bare ulna bones having a natural curvature. The bare poultry bones 112 with a curvature are oriented such that the concave surface is upward on the substrate. In another example, the curvature of the bare poultry bones is oriented in a convex manner such that the curvature is facing the substrate.

The number of bare bones 112 used is optionally dependent on the size of the bone-in poultry food product specified. In an example, a poultry food product 100 is similar to a rack of beef or pork ribs.

FIG. 10 illustrates another step in an example process for creating the poultry food product 100. The poultry food product 100 is assembled from at least two components — one or more bare poultry bones 112 and processed poultry meat 114 (e.g. a meat-ulna or meat-radius assembly). The poultry food product 100 shown in FIG. 10 has a similar appearance to a beef or pork rack of ribs. Other bone-in red meat food products can be formed or generated with the process described herein including, but not limited to, chops, bone-in steaks, such as a ribeye, porterhouse, or the like. The process described is implemented with the same or different bare poultry bones.

In the example using multiple bare poultry bones as illustrated in FIG. 10, three bare bones 112 are positioned on a plastic film with sufficient spacing for placement of processed poultry meat between the bones. The brined and bare poultry bones 112 are aligned in an arrangement emulating a rack or partial rack of ribs. The brined and bare poultry bones 112 are arranged in a rack configuration (e.g., with the bones parallel, near to parallel, aligned or the like). For example, one or more ulna bones one or more radius bones, one or more ulna bone and radius bones in combination, or the like are arranged for the poultry food product.

While the example illustrated in FIG. 10 shows bare bones positioned on a plastic film, any supporting substrate is contemplated. Such substrates can include a tray, pan or similar near flat surface.

Referring again to FIG. 10, the processed poultry meat 114 is placed along the one or more brined poultry bones. In an example, the brined and bare poultry bones 112 support the processed poultry meat 114, for instance the meat 114 is positioned over the bones, between the bones, around the bones or the like.

The processed poultry meat 114, in an example, is at least one of whole muscle poultry meat, shredded, ground, chopped, combination of poultry meat types or the like. Optionally, the texture of the poultry food product is dependent on the type of processed meat used. In one example, the processed poultry meat 114 is chopped, raw poultry meat. The chopped, raw poultry meat provides a meatier texture. In another example, emulsified poultry meat provides a texture similar to a hot dog. In another example, ground poultry meat provides a texture similar to a sausage or bratwurst. In still another example, whole muscle poultry meat provides a texture similar to chicken or turkey because the poultry meat is processed with the whole (or near whole) muscle retained. In another example, different types of processed meat are optionally combined. For instance, ground meat is combined with chopped meat or chopped meat is combined with emulsified meat. The processed meat used can depend on the specified texture of the final product.

The processed poultry meat 114, in any of the preceding examples, can be combined with, for example, a brine. The brine used, for example, is a salt and phosphate solution and is added to the processed poultry meat to retain or trap water in the processed poultry meat. In other examples, processed poultry meat includes binders such as, but not limited to, gelatins, sodium casinate, transglutaminase, and wheat glutens. Binders are optionally included individually or in combination to the processed poultry meat to assist in binding the processed poultry meat together or assist in coupling (e.g., connecting, binding or adhesion) of the processed poultry meat to the bone. In other examples, seasonings and spices are added to the processed poultry meat to achieve a specified flavor. Brining the processed poultry meat can facilitate coupling (e.g., connect, bind or adhere) between the bare poultry bone and the processed poultry meat. The processed meat and brine mixture, in an example, is then subjected to vacuum or low-pressure conditions for a desired period of time. In other examples, the processed poultry meat is coupled to the bare poultry bones without brining or seasoning. Instead, an end user (e.g., a cook) may apply seasoning to taste.

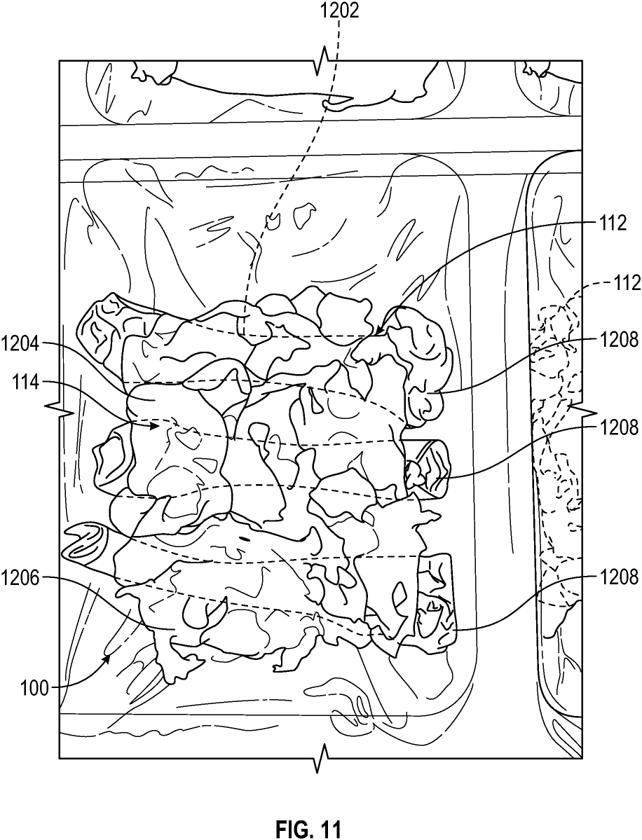

FIG. 11 is a detailed view of the processed meat 114 surrounding at least a portion of the bare poultry bones 112. In an example, the processed poultry meat 114 surrounds (e.g., covers, partially covers or the like) at least a portion of the top surface 1202 of the bare poultry bone 112. In an example of a poultry food product 100 where more than one bare poultry bone is used, the processed poultry meat 114 surrounds at least the top of the bare poultry bone 112 and fills the space between adjacent bones. The processed poultry meat 114, in some examples, is placed under the bare poultry bone. In this example, the processed poultry meat and multiple bare poultry bones form one poultry food product with the appearance of a red meat rack of ribs. In an example where more than one bare poultry bone is used, the processed poultry meat is placed adjacent to the bare poultry bone in manner that extends past the surface of the bare poultry bone 1206 and onto the substrate which supports the poultry food product 100. In an example, the processed poultry meat surrounds the bare poultry bone in a manner that the longitudinal ends of the bare poultry bone are exposed 1208.

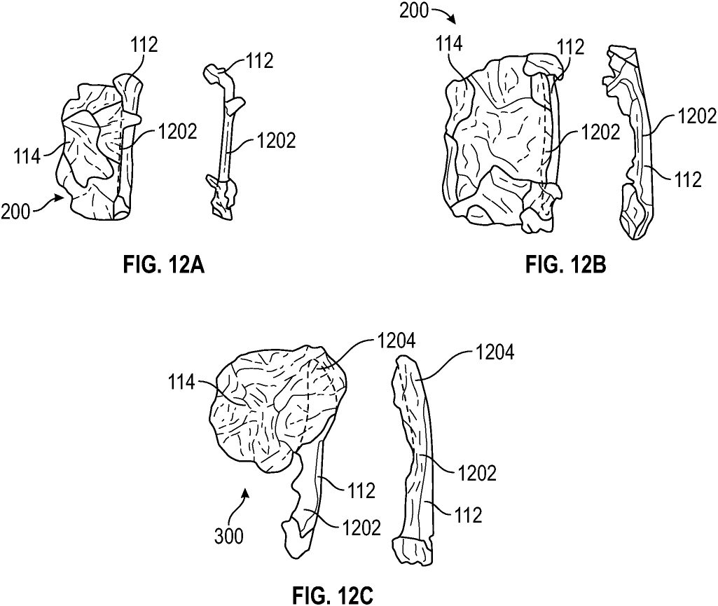

FIGS. 12A-C illustrate examples of assembled food products, such as a food product 200 and food product 300. The example food product 200 and food product 300 can be poultry food products that resemble a bone-in red meat product such as a pork chop, lamb chop or the like. As shown in FIG. 12A, food product 200 in this examples includes the length (e.g., all, substantially all, with an incidental portion of the bone exposed or the like) of one side of a poultry bone 112 covered with processed meat 114. Food product 200, as illustrated in FIGS. 12A and 12B, can be an example of food product 200 with the processed meat 114 covering, surrounding, or otherwise placed in contact with the length of one side of a bare poultry bone 112.

For example, as illustrated in FIG. 12A, the processed meat 114 is placed on a side (e.g., left or right) of the bare poultry bone 112 so at least a portion of the left or right side of the bare poultry bone 112 is at least partially covered with the processed meat 114. The food product 200 illustrated in FIG. 12A includes the processed meat 114 covering a length of the side of the bare poultry bone 112 (e.g., all, substantially all, with an incidental portion of the bone exposed or the like). As illustrated in FIG. 12B, the processed meat 114 is placed so a surface of the bare poultry bone 112 is covered (e.g., the left surface in FIG. 12B). The processed meat 114 can be placed so either or both of the left or right surfaces of the poultry bone 112 are covered. The processed meat 114 can be placed where at least a portion top surface 1202 of the poultry bone 112 is covered. Food product 200 is an example of a poultry food product that resembles, in a finished form, a bone-in red meat product such as a bone-in ribeye pork chop or the like.

Food product 300, as illustrated in FIG. 12C, shows an example food product with the processed meat 114 at least partially covering an upper portion 1204 and the top surface 1202 of the poultry bone 112. As shown in FIG. 12C, food product 300 includes the upper portion 1204 of a poultry bone 112 covered (e.g., all, substantially all, with an incidental portion of the upper portion 1204 exposed or the like). The processed meat 114 can be placed so either a left upper portion or right upper portion is covered, surrounded or the like. The processed meat 114 covers the upper portion 1204 of the bare poultry bone(e.g., all, substantially all, with an incidental portion of the bone exposed or the like). The processed meat 114 can be placed so a portion of the upper portion 1204 of the bare poultry bone is covered. The food product 300 is an example of a poultry food product which, in a finished form, can resemble a bone-in red meat product such as a pork chop or lamb chop or the like.

The poultry bones 112 shown in FIGS. 12A, B and Cvary in size, shape, original animal (e.g., in some examples non-poultry bones) or the like (collectively profile). The poultry bones 112 in the above examples are optionally uniform in profile (e.g., size, shape or the like). The food products 100, 200 or 300 can be formed with poultry bones 112 (or bones from another animal) that can also allow for some profile variation differences in size or shape. In one example, the profile of the ulna or radius bone differs between food products 100, 200 or 300. In other examples, the quantity of processed meat 114 coupled with the bone of food products 100, 200 or 300 varies based on the profile of the poultry bone 112 used (e.g., larger bones provide more surface area to bond with a larger quantity of meat).

The quantity of processed meat surrounding the brined and bare poultry bone depends on at least one of the size or quantity of prepared processed poultry meat for the specified poultry food product. In some examples, the ratio of prepared processed poultry meat to brined and bare poultry bone is three to one. In other examples using a larger bare poultry bone, the ratio of processed meat to brined and bare poultry bone is two to one. In each of the preceding examples, processed poultry meat may be used instead of prepared processed poultry meat.

The assembled poultry food product 100 (brined and bare poultry bones surrounded with prepared processed poultry meat) can be processed to coupled (e.g., adhere connect, bind) the prepared processed poultry meat to the brined and bare poultry bones. Coupling the prepared processed poultry meat to the bare bone forms a food product which is similar in appearance to a bone-in food product. The prepared processed poultry meat is coupled (e.g., connected, bound, adhered) to the brined and bare poultry bone in a manner requiring cutting, biting or other similar applications to remove the meat from the bone. In each of the preceding examples, processed poultry meat may be used instead of prepared processed poultry meat.

In an example of forming the poultry food product, a covering is placed on top of the assembled poultry food product thereby enclosing the assembled food product within a container. In another example, the assembled poultry food product is exposed pressures less than atmospheric, such as vacuum pressure, to couple the meat to the bare and brined poultry food product. In another example, the assembled food product is placed in a prefabricated mold and processed to create the poultry food product.

In an example, after the poultry food product is formed the assembled poultry food product is cooked, or heat treated, to further couple the prepared processed poultry meat to the bare poultry bones. In another example, after the poultry food product is formed, the assembled poultry food product is placed in a cold temperature environment or refrigerated to further couple the processed poultry meat with the brined and bare poultry bones. Any of the above examples, can be combined to create the poultry food product.

### Various Notes and Aspects

One aspect of the present poultry food product includes one or more bare poultry bones separated from the remainder of poultry wings, wherein the one or more bare poultry bones are stripped (entirely cleaned, or removed with incidental meat remaining) of poultry muscle or skin. The one or more separated bare poultry bones are brined in a salt solution. The poultry food product includes the one or more brined and bare poultry bones, a quantity of processed poultry meat surrounding the one or more brined and bare poultry bones. The processed poultry meat is coupled to the one or more brined and bare poultry bone.

A second aspect of the present poultry food product includes bare one or more bare poultry bones where the poultry bones are one of an ulna bone or radius bone and are completely stripped of poultry muscle or skin.

A third aspect of the present poultry food product includes the one or more bare poultry bones which includes two or more brined and separated bare ulna bones, and the quantity of processed poultry meat surrounds each of the two or more bare ulna bones.

A fourth aspect of the present poultry food product includes processed poultry meat selected from at least one of whole muscle, chopped, ground and emulsified poultry meat.

A fifth aspect of the present poultry food product includes cooking the poultry food product.

A sixth aspect of the present poultry food product includes the bare poultry bone is separated from the remainder of the poultry wing by isolating a radius and ulna subassembly, separate from a humerus and alula bone.

A seventh aspect of the present poultry food product includes the bare ulna bone being separated from the radius bone.

An eight aspect of the present poultry food product includes poultry food product is within a substrate and subjected to a pressure less than ambient pressure for a sufficient amount of time to couple the processed poultry meat to the brined and separated bare poultry bone.

A ninth aspect of the present poultry food product includes a poultry food produced formed from a poultry wing bone and processed poultry meat comprising a bare poultry bone separated from the remaining skeletal structure of a poultry wing. The bare poultry bone is brined. The poultry food product comprises a quantity of processed poultry meat. The poultry food product comprises a meat-ulna assembly including the quantity of processed poultry meat surrounds and is coupled to the brined, bare and separated poultry bone.

A tenth aspect of the present poultry food product includes at least two ulna bones or at least two radius bones each surrounded with the quantity of processed poultry meat and coupled together.

An eleventh aspect of the present poultry food product includes the bare and separated poultry bone is a discarded ulna or radius bone.

A twelfth aspect of the present poultry food product includes a radius and ulna subassembly, separate from a humerus and an alula, separated from the poultry wing.

A thirteenth aspect of the present a method of separating and removing one or more bones from a poultry carcass comprising harvesting a bare ulna or radius bone, removing skin from a poultry wing of the poultry carcass; removing muscle tissue from at least an area of the poultry wing including an ulna bone or a radius by isolating the bare ulna bone or bare radius bone from the remainder of the poultry wing. Isolating the bare ulna or bare radius bone includes separating the bare ulna bone from a radius bone of the poultry wing, removing the bare ulna bone or bare radius from the remaining poultry wing and poultry carcass.

A fourteenth aspect of the present method of separating and removing one or more bones from a poultry carcass includes separating the poultry wing from the poultry carcass and completely removing the skin and muscle from the poultry wing.

A fifteenth aspect of the present method of separating and removing one or more bones from a poultry carcass includes cutting at an elbow joint and a carpal joint to separate a radius and ulna subassembly, separate the subassembly from the humerus and alula, from the poultry wing. The radius and ulna subassembly includes the ulna bone coupled with the radius bone. Removing the coupled ulna and radius bones from the poultry carcass, cutting proximate a juncture of each end of the radius and ulna subassembly; and removing the ulna from the radius bone according to the cuts.

A sixteenth aspect of the present method of separating and removing one or more bones from a poultry carcass includes making a cut at a radial notch and another cut at an ulnar notch and removing the ulna bone while the remaining skeletal structure of the poultry wing remains intact.

A seventeenth aspect of the present method of separating and removing one or more bones from a poultry carcass includes brining the bare ulna bone and surrounding the bare and brined ulna bone with a quantity of processed poultry meat. The processed poultry meat is selected from at least one of whole muscle, chopped, ground and emulsified poultry meat. Adhering the processed poultry meat to the brined and bare ulna bone. Placing the processed poultry meat coupled to the brined and bare ulna bone within a container and subjected to a pressure less than ambient pressure for a sufficient amount of time to couple the processed poultry meat to the brined and separated bare ulna bone.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms "a" or "an" are used, as is common in patent documents, to include one or more than one, independent of any other instances or usages of "at least one" or "one or more." In this document, the term “or” is used to refer to a nonexclusive or, such that "A or B" includes “A but not B,” “B but not A,” and "A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A poultry food product comprising:
one or more bare poultry bones separated from the remainder of poultry wings, wherein the one or more bare poultry bones are stripped of poultry muscle or skin;
wherein the one or more separated bare poultry bones are brined in a salt solution; and
wherein the poultry food product includes:
the one or more brined and separated bare poultry bones;
a quantity of processed poultry meat surrounding the one or more brined and separated bare poultry bones; and
wherein the processed poultry meat is coupled to the one or more brined and separated bare poultry bone.

2. The poultry food product of claim 1, wherein the one or more bare poultry bones are ulna or radius bones completely stripped of poultry muscle or skin.

3. The poultry food product of claim 1, wherein the one or more bare poultry bones includes two or more brined and separated bare ulna or radius bones, and the quantity of processed poultry meat surrounds each of the two or more bare ulna or radius bones.

4. The poultry food product of claim 1 wherein the processed poultry meat is selected from at least one of whole muscle, shredded, chopped, ground and emulsified poultry meat.

5. The poultry food product of claim 1 wherein the poultry food product is cooked.

6. The poultry food product of claim 1 wherein the bare poultry bone is an ulna or radius bone separated from the remainder of the poultry wing by isolating a radius and ulna subassembly, separate from a humerus and alula bone.

7. The poultry product of claim 6, wherein the bare ulna bone is separated from the from the radius bone.

8. The poultry product of claim 1 wherein the poultry food product is within a container and subjected to a pressure less than ambient pressure for a sufficient amount of time to couple the processed poultry meat to the brined and separated bare poultry bone.

9. A poultry food produced formed from a poultry wing bone and processed poultry meat comprising:
a bare poultry wing bone separated from the remaining skeletal structure;
wherein, the bare poultry bone is brined;
a quantity of processed poultry meat; and
a meat-bare poultry wing bone assembly including:
the quantity of processed poultry meat surrounds and is coupled to the brined, bare and separated poultry wing bone.

10. The poultry food product of claim 9 wherein:
the bare poultry wing bone is at least two ulna bones or at least two radius bones each surrounded with the quantity of processed poultry meat; and
coupled together.

11. The poultry food product of claim 9 wherein the bare and separated poultry wing bone is a discarded ulna or radius bone.

12. The poultry food product of claim 9 wherein the processed poultry meat is at least one of whole muscle, shredded, chopped, ground or emulsified.

13. The poultry food product of claim 9 wherein the poultry food product is cooked.

14. The poultry food product of claim 9 wherein the bare and separated poultry wing bone is brined in a salt solution.

15. The poultry product of claim 9 wherein a radius and ulna subassembly, separate from a humerus and an alula, is separated from the poultry wing.

16. The poultry product of claim 9 wherein the one or more bare poultry wing bones are separated from the remainder of the poultry wing as a radius and ulna subassembly separate from a humerus and alulas; and
the one or more bare ulna bones are separated from the associated radius bones of the radius and ulna subassemblies.

17. The poultry food product of claim 9, wherein the meat-bare poultry wing bone assembly is within a substrate and subjected to a pressure less than ambient pressure for a sufficient amount of time to couple the processed poultry meat to the brined and separated bare poultry wing bone.

18. A method of separating and removing one or more bones from a poultry carcass comprising:
harvesting a bare ulna bone or radius bone including:
removing skin from a poultry wing of the poultry carcass; and
removing muscle tissue from at least an area of the poultry wing including an ulna bone or radius bone; and
isolating the bare ulna bone or bare radius bone form the remainder of the poultry wing, wherein isolating the bare ulna bone or radius bone includes:
separating the bare ulna bone from a radius bone of the poultry wing; and
removing the bare ulna bone or radius bone from the remaining poultry wing and poultry carcass.

19. A method of separating and removing one or more bones from a poultry carcass of claim 18, further comprising:
separating the poultry wing from the poultry carcass; and
completely removing the skin and muscle tissue from the poultry wing.

20. A method of separating and removing one or more bones from a poultry carcass of claim 18, wherein isolating the ulna bone from the remainder of the poultry wing includes:
cutting at an elbow joint and a carpal joint to separate a radius and ulna subassembly, separate from the humerus and alula, from the poultry wing;
wherein the radius and ulna subassembly includes the ulna bone coupled with the radius bone;
removing the coupled ulna and radius bones from the poultry carcass;
cutting proximate a juncture of each end of the radius and ulna subassembly; and
removing the ulna from the radius bone according to the cuts.

21. A method of separating and removing one or more bones from a poultry carcass of claim 18, wherein separating the ulna bone from the radius bone further comprises:
making a cut at a radial notch and another cut at an ulnar notch; and
removing the ulna bone while the remaining skeletal structure of the poultry wing remains intact.

22. A method of separating and removing one or more bones from a poultry carcass of claim 18, further comprising:
brining the bare ulna bone;
surrounding the bare and brined ulna bone with a quantity of processed poultry meat;
wherein the processed poultry meat is selected from at least one of chopped, ground and emulsified poultry meat;
adhering the processed poultry meat to the brined and bare ulna bone; and
placing the processed poultry meat coupled to the brined and bare ulna bone within a container and subjected to a pressure less than ambient pressure for a sufficient amount of time to couple the processed poultry meat to the brined and separated bare ulna bone.
